(19) United States
(12) Patent Application Publication
(10) Pub. No.: US 2020/0149475 A1
(43) Pub. Date: May 14, 2020

(54) COMBINED HIGH PRESSURE TURBINE CASE AND TURBINE INTERMEDIATE CASE

(71) Applicant: United Technologies Corporation, Farmington, CT (US)

(72) Inventors: Dale William Petty, Wallingford, CT (US); Karl D. Blume, Hebron, CT (US); Joseph T. Caprario, Rocky Hill, CT (US); Steven J. Bauer, East Haddam, CT (US)

(21) Appl. No.: 16/595,883

(22) Filed: Oct. 8, 2019

Related U.S. Application Data
(63) Continuation of application No. 14/427,652, filed on Mar. 12, 2015, now abandoned.
(60) Provisional application No. 61/705,795, filed on Sep. 26, 2012.

(51) Int. Cl. F02C 7/20; F01D 25/24; F01D 11/00; F01D 25/16; F02C 3/045

(52) U.S. Cl. CPC F02C 7/20; F01D 25/246; F01D 25/243; F01D 11/005; Y10T 29/49826; F02C 3/045; F01D 25/24; Y02T 50/671; F01D 25/162

(57) ABSTRACT

A disclosed gas turbine engine includes a compressor section, a combustor section, a first turbine section and a second turbine section. An outer case structure for the gas turbine engine includes a single-piece case structure with a turbine case portion and a transition case portion. The transition case portion is integrally formed with the turbine case portion as a single part module. A combustor case houses the combustor and an aft turbine case supports the low pressure turbine. The outer case includes a forward end attachable to the combustor case and an aft end attachable to the aft turbine.

### CROSS REFERENCE TO RELATED APPLICATION

This application is a continuation of U.S. patent application Ser. No. 14/427,652 filed on Mar. 12, 2015, which is a 371 National Phase Application of International Patent Application No. PCT/US2013/031125 filed on Mar. 14, 2013, which claims priority to U.S. Provisional Application No. 61/705,795 filed on Sep. 26, 2012.

### BACKGROUND

A gas turbine engine typically includes a fan section, a compressor section, a combustor section and a turbine section. Air entering the compressor section is compressed and delivered into the combustion section where it is mixed with fuel and ignited to generate a high-speed exhaust gas flow. The high-speed exhaust gas flow expands through the turbine section to drive the compressor and the fan section. The compressor section typically includes low and high pressure compressors, and the turbine section includes low and high pressure turbines.

The engine includes multiple case structures that are attached together for define an overall engine static support structure. An interface between each case includes flanges on each case for a plurality of fasteners. Each flange requires specific structures to not only provide the desires structure, but also to prevent leakage. The structure at each flange adds weight to the overall engine and requires additional time during assembly.

Turbine engine manufacturers continue to seek further improvements to engine performance and assembly including improvements to thermal, transfer, assembly and propulsive efficiencies.

### SUMMARY

A case for a gas turbine engine according to an exemplary embodiment of this disclosure, among other possible things includes a single unitary outer case including a turbine portion and a transition portion. The outer case includes a forward end attachable to a combustor case and an aft end attachable to an aft turbine case.

In a further embodiment of the foregoing case, includes a turbine intermediate frame supported within the transition case portion.

In a further embodiment of any of the foregoing cases, the case includes at least one continuous uninterrupted outer surface that extends from the forward end to the aft end.

In a further embodiment of any of the foregoing cases, the turbine portion at least partially surrounds a high pressure turbine.

In a further embodiment of any of the foregoing cases, includes a mounting flange disposed about an outer surface of the case between the forward end and the aft end.

In a further embodiment of any of the foregoing cases, includes hooks within the turbine portion for supporting at least one blade outer seal assembly.

In a further embodiment of any of the foregoing cases, includes hooks for supporting at least one vane.

A gas turbine engine according to an exemplary embodiment of this disclosure, among other possible things includes a compressor section disposed within a combustor case, a combustor section, a first turbine section and a second turbine section, a single-piece outer case including a turbine portion and a transition portion, and an aft turbine case. The outer case includes a forward end attachable to the combustor case and an aft end attachable to the aft turbine case.

In a further embodiment of the foregoing gas turbine engine, the turbine portion surrounds the first turbine section and the aft turbine case surrounds the second turbine section.

In a further embodiment of any of the foregoing gas turbine engines, includes a turbine intermediate frame supported within the transition portion of the outer case.

In a further embodiment of any of the foregoing gas turbine engines, the outer case includes a continuous uninterrupted outer surface that extends from the forward end to the aft end.

In a further embodiment of any of the foregoing gas turbine engines, includes a mounting flange disposed about an outer surface of the outer case between the forward and aft ends.

In a further embodiment of any of the foregoing gas turbine engines, the turbine portion of the outer case includes hooks for supporting a blade outer seal assembly.

In a further embodiment of any of the foregoing gas turbine engines, includes hooks for supporting at least one vane.

A method of assembling a gas turbine engine according to an exemplary embodiment of this disclosure, among other possible things includes defining an outer case as a single unitary structure that includes a turbine portion for a first turbine and a transition portion for a turbine intermediate frame, attaching a forward end of the outer case to a combustor case such that a turbine portion of the outer case surrounds the first turbine, assembling the turbine intermediate frame into the transition portion of the outer case, and attaching an aft turbine case to an aft end of the outer case.

In a further embodiment of the foregoing method, includes configuring the outer case to include at least one continuous uninterrupted outer surface that extends from the forward end to the aft end.

In a further embodiment of any of the foregoing methods, includes assembling a blade outer air seal assembly within the turbine portion of the outer case.

In a further embodiment of any of the foregoing methods, includes assembling a bearing assembly into the outer case within the transition portion prior to attaching of the aft turbine case.

In a further embodiment of any of the foregoing methods, includes defining a mounting flange for attaching accessory components on an outer surface of the outer case between the forward end and the aft end.

Although the different examples have the specific components shown in the illustrations, embodiments of this disclosure are not limited to those particular combinations. It is possible to use some of the components or features from one of the examples in combination with features or components from another one of the examples.

These and other features disclosed herein can be best understood from the following specification and drawings, the following of which is a brief description.

### BRIEF DESCRIPTION OF THE DRAWINGS

FIG. 1 is a schematic view of an example gas turbine engine.

FIG. 2 is a perspective view of an example outer case.

FIG. 3 is a cross-section of the example outer case and corresponding components mounting within the outer case.

FIG. 4 is a cross-section showing a prior art case configuration.

FIG. 5 is a cross-section of the example outer case in an initial assembly condition.

FIG. 6 is another cross-section illustrating assembly of the outer case within the high pressure turbine section.

FIG. 7 is a further cross-section illustrating assembly of an intermediate frame within the example outer case.

FIG. 8 is a further cross-section illustrating the assembly of a bearing assembly within the example outer case.

FIG. 9 is another cross-section illustrating the completed assembly of components within the example outer case.

### DESCRIPTION

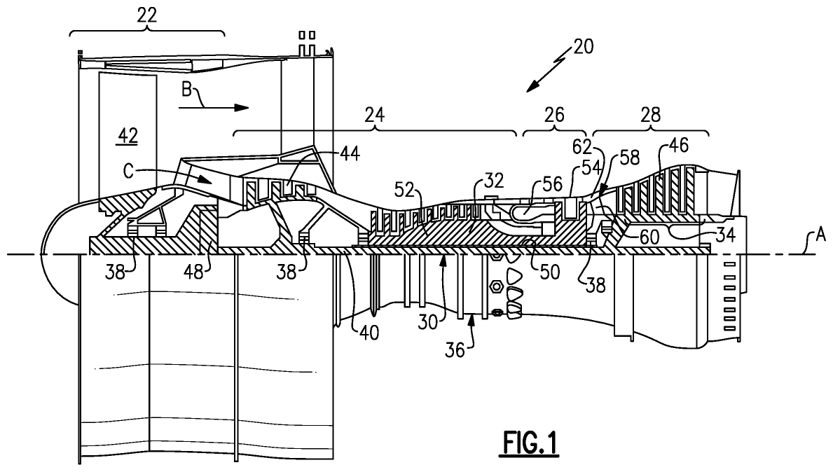

FIG. 1 schematically illustrates a gas turbine engine 20. The gas turbine engine 20 is disclosed herein as a two-spool turbofan that generally incorporates a fan section 22, a compressor section 24, a combustor section 26 and a turbine section 28. Alternative engines might include an augmentor section (not shown) among other systems or features. The fan section 22 drives air along a bypass flowpath B while the compressor section 24 drives air along a core flowpath C for compression and communication into the combustor section 26 then expansion through the turbine section 28. Although depicted as a turbofan gas turbine engine in the disclosed non-limiting embodiment, it should be understood that the concepts described herein are not limited to use with turbofans as the teachings may be applied to other types of turbine engines including three-spool architectures.

The engine 20 generally includes a first spool 30 and a second spool 32 mounted for rotation about an engine central axis A relative to an engine static structure 36 via several bearing systems 38. It should be understood that various bearing systems 38 at various locations may alternatively or additionally be provided.

The first spool 30 generally includes a first shaft 40 that interconnects a fan 42, a first compressor 44 and a first turbine 46. The first turbine includes a plurality of rotors 34. The first shaft 40 is connected to the fan 42 through a gear assembly of a fan drive gear system 48 to drive the fan 42 at a lower speed than the first spool 30. The second spool 32 includes a second shaft 50 that interconnects a second compressor 52 and second turbine 54. The first spool 30 runs at a relatively lower pressure than the second spool 32. It is to be understood that “low pressure” and “high pressure” or variations thereof as used herein are relative terms indicating that the high pressure is greater than the low pressure. An annular combustor 56 is arranged between the second compressor 52 and the second turbine 54. The first shaft 40 and the second shaft 50 are concentric and rotate via bearing systems 38 about the engine central axis A which is collinear with their longitudinal axes.

Airflow through the core airflow path C is compressed by the first compressor 44 then the second compressor 52, mixed and burned with fuel in the annular combustor 56, then expanded over the second turbine 54 and first turbine 46. The first turbine 46 and the second turbine 54 rotationally drive, respectively, the first spool 30 and the second spool 32 in response to the expansion.

The engine 20 is a high-bypass geared aircraft engine that has a bypass ratio that is greater than about six (6), with an example embodiment being greater than ten (10), the gear assembly of the fan drive gear system 48 is an epicyclic gear train, such as a planetary gear system or other gear system, with a gear reduction ratio of greater than about 2.3:1 and the first turbine 46 has a pressure ratio that is greater than about 5. The first turbine 46 pressure ratio is pressure measured prior to inlet of first turbine 46 as related to the pressure at the outlet of the first turbine 46 prior to an exhaust nozzle. The first turbine 46 has a maximum rotor diameter and the fan 42 has a fan diameter such that a ratio of the maximum rotor diameter divided by the fan diameter is less than 0.6. It should be understood, however, that the above parameters are only exemplary.

A significant amount of thrust is provided by the bypass flow B due to the high bypass ratio. The fan section 22 of the engine 20 is designed for a particular flight condition—typically cruise at about 0.8 Mach and about 35,000 feet. The flight condition of 0.8 Mach and 35,000 feet, with the engine at its best fuel consumption. To make an accurate comparison of fuel consumption between engines, fuel consumption is reduced to a common denominator, which is applicable to all types and sizes of turbojets and turbofans. The term is thrust specific fuel consumption, or TSFC. This is an engine's fuel consumption in pounds per hour divided by the net thrust. The result is the amount of fuel required to produce one pound of thrust. The TSFC unit is pounds per hour per pounds of thrust (lb/hr/lb Fn). When it is obvious that the reference is to a turbojet or turbofan engine, TSFC is often simply called specific fuel consumption, or SFC. “Low fan pressure ratio” is the pressure ratio across the fan blade alone, without a Fan Exit Guide Vane system. The low fan pressure ratio as disclosed herein according to one non-limiting embodiment is less than about 1.45. “Low corrected fan tip speed” is the actual fan tip speed in feet per second divided by an industry standard temperature correction of [(Tram ° R)/(518.7° R)]^{0.5}. The “Low corrected fan tip speed” as disclosed herein according to one non-limiting embodiment is less than about 1150 feet per second.

The engine 20 can include various case structures, around the turbine section 28 for example. A case can include multiple pieces that are connected at a flange. Case flanges add weight, are potential leak paths, are difficult to design in areas with large thermal gradients, (as in hot section case flanges) can decrease engine backbone stiffness, and can add assembly time for snap heating and bolt fastening. Removal of an engine flange can improve all the above.

The engine static structure 36 includes an outer case 62 that combines a high pressure turbine case and intermediate turbine case into one piece, thereby eliminating an engine flange. One or more rails are retained on the outer case 62 to provide a connection point for external bracket fastening for other components and to tune case stiffness.

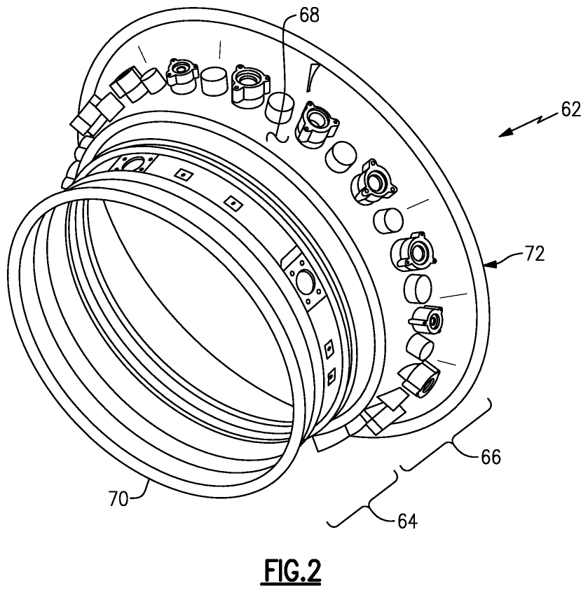

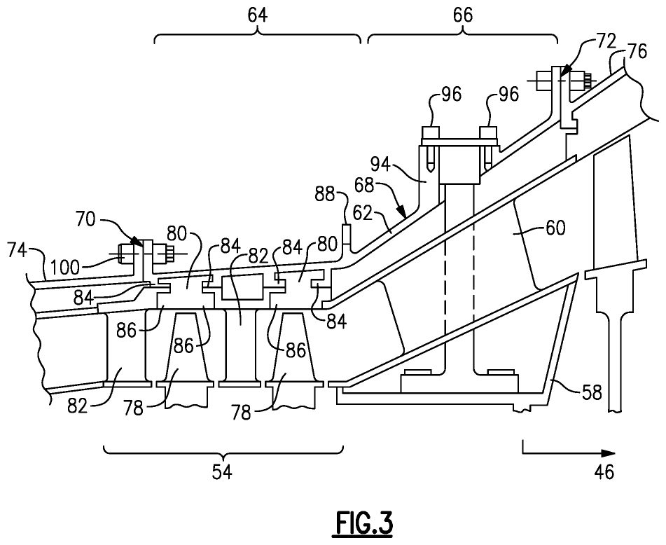

Referring to FIGS. 2 and 3, with continued reference to FIG. 1, the example engine static structure 36 includes the outer case 62 that houses the high pressure turbine 54 and an intermediate turbine frame 58. The example outer case 62 is a single continuous unitary structure from a forward end 70 that is attachable to a combustor case 74 to an aft end 72 that is securable to an aft turbine case 76. An outer surface 68 of the outer case 62 extends uninterrupted from the forward end 70 to the aft end 72.

The example outer case 62 includes a turbine portion 64 that surrounds the high pressure turbine 54. The turbine portion 64 also includes features for supporting fixed structures of the high pressure turbine 54.

The outer case 62 also includes a transition portion 66 aft of the turbine portion 64 that surrounds and supports an intermediate turbine frame 58 including an airfoil 60 for directing air between the high pressure turbine 54 and the low pressure turbine 46.

In this example, the aft turbine case 76 houses the low pressure turbine 46. The turbine portion 64 of the outer case 62 houses the high pressure turbine 54 and features that correspond and utilize for operation of the high pressure turbine 54. The high pressure turbine 54 includes two (2) rotatable stages 78 and two (2) static stages or vanes 82. The outer case 62 includes hooks 84 to support blade outer air seal assemblies (BOAS) 80. The BOAS assemblies 80 are disposed radially out board of the rotating blades 78 of the high pressure turbine 54.

The hooks 84 are constructed for mounting not only the blade outer air seal assemblies 80 but also for mounting of the vanes 82. Each of the vanes 82 are supported on hooks 86 provided on the blade outer air seal assemblies 80.

The outer case 62 includes the single continuous surface 68 from the forward end 70 to the aft end 72. This single continuous surface defines a single monolithic structure including features for supporting and mounting components such as the BOAS assemblies 80 and the airfoil 60.

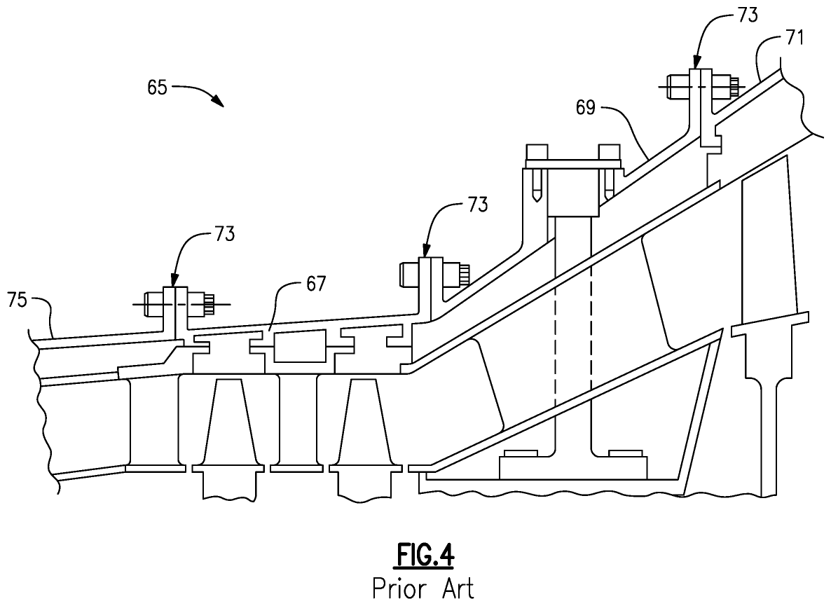

Referring to FIG. 4, with continued reference to FIG. 3, FIG. 4 illustrates a prior art case assembly 65 that includes a combustor case 75, a high pressure turbine case 67, an intermediate case 69, and a low pressure turbine case 71. A flanged connection 73 is required between each of the individual cases. As appreciated, each flanged connection 73 requires a significant number of fasteners to provide the desired attachment and securement. Moreover, each flanged connection 73 complicates assembly of an engine and limits mounting space and locations for devices and components that are mounting to the external static structure of the engine assembly.

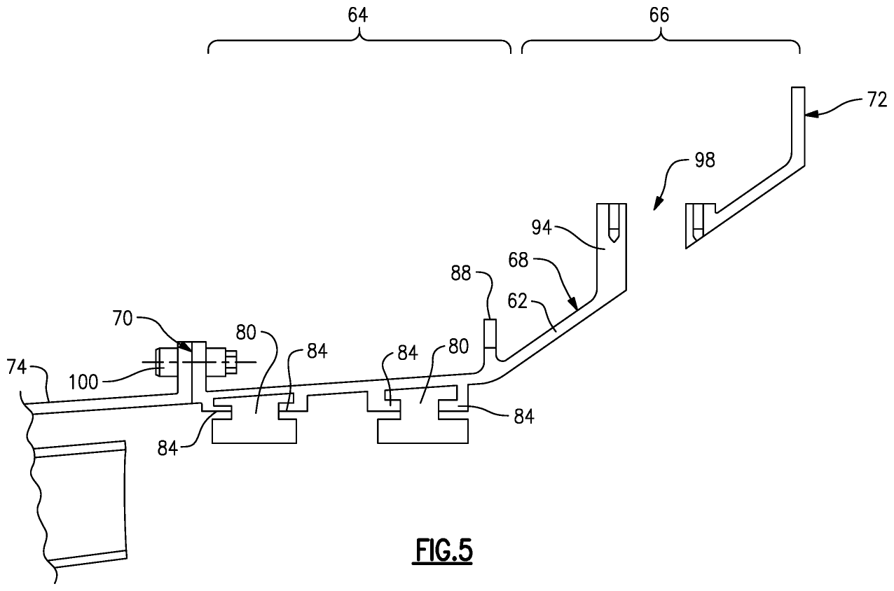

Referring to FIG. 5, with continued reference to FIG. 3, the example outer case 62 assembly starts by first installing the blade outer air seal assemblies 80 into the hooks 84. The hooks 84 are in integral feature of the outer case 62.

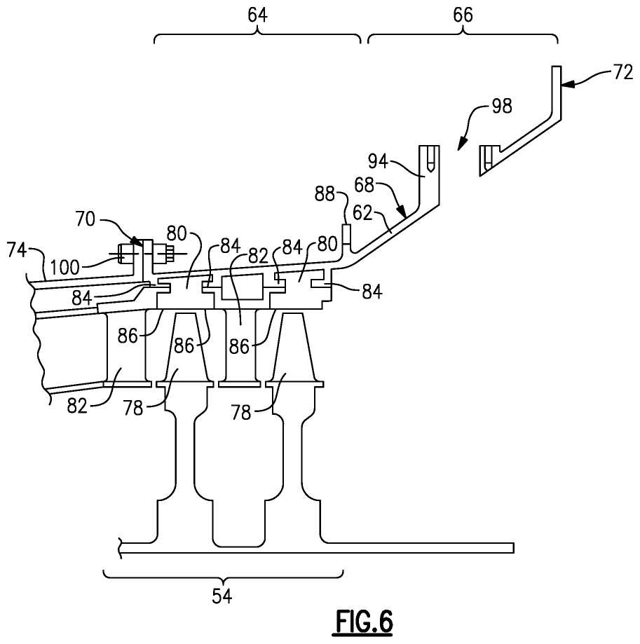

Referring to FIG. 6, with continued reference to FIG. 5, once the blade outer air seal assemblies 80 are secured within the outer case 62, the high pressure turbine vanes 82 are installed. The vanes 82 are supported on hooks 86 defined on the blade outer air seal assemblies 80. After the vanes 82 are installed, the high pressure turbine 54 is installed. The outer case 62 assembly and high pressure turbine 54 are then assembled concurrently to the engine 20.

The outer case 62 is attached to the combustor case 74 at the forward end 70. The forward end 70 is a flange that is secured to the combustor case 74 with a plurality of fasteners 100 (only one shown here). The plurality of fasteners 100 are circumferentially spaced about the flanged connection between outer case 62 and the combustor case 74.

The outer case 62 includes an opening 98 and a corresponding boss 94 for securing the turbine intermediate frame 58.

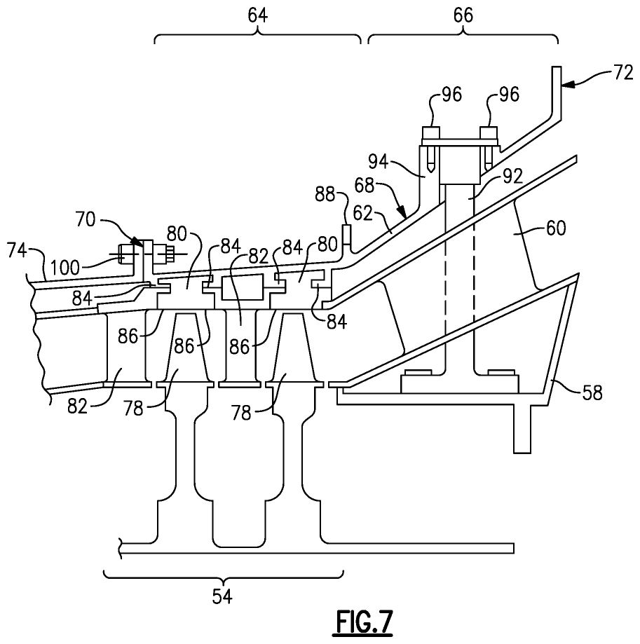

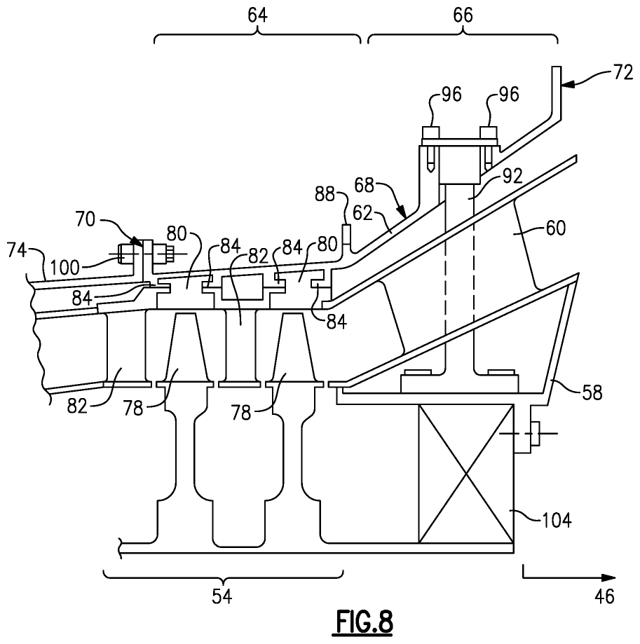

Referring to FIG. 7, with continued reference to FIG. 3, assembly of components within the outer case 62 continues with assembly of the turbine intermediate frame 58. The example turbine intermediate frame 58 includes a strut 92 that supports a bearing assembly (FIG. 8) utilized to support the shafts 40 and 50 of the high and low spools. The support strut 92 extends through the opening 98 and is secured by way of fasteners 96 to the boss 94 defined on the outer surface 68 of the outer case 62.

The turbine intermediate frame 58 defines a transition duct between the high pressure turbine 54 and the low pressure turbine 46. The intermediate turbine frame 58 includes the airfoil 60 that conditions and directs airflow between the high pressure turbine 54 and the low pressure turbine 46. In this example, there are no flange connections between the combustor case 74 and the aft case 76 and therefore, assembly is substantially simplified. All that is required is assembly of the support strut 92 and the airfoil 60 within the transition portion 66 of the outer case 62.

As appreciated, some components are mounted to the outer case 62 and the elimination of a flange also eliminates an attachment point. The outer case 62 includes a flange 88 that extends upward transversely from the outer surface 68. The mounting flange 88 provides a location to which various components can be secured to the outer surface 68 of the outer case 62. The mounting flange 88 also adds rigidity to the outer case 62.

Referring to FIG. 8, with continued reference to FIG. 3, the bearing assembly 104 is installed after the turbine intermediate frame 58 is secured to the outer case 62. The bearing assembly 104 is secured to the turbine intermediate frame 58.

Although the example bearing assembly 104 is assembled as a separated component from turbine intermediate frame 58, it may also be assembled as a unit with the turbine intermediate frame 58.

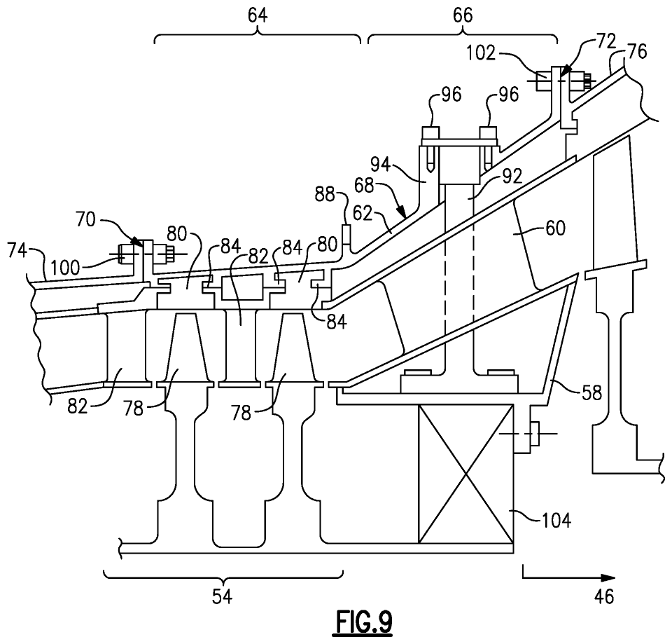

Referring to FIG. 9, once the bearing assembly 104 is assembled, the aft turbine case 76 can be attached to the outer case 62. The aft turbine case 76 is assembled and secured by a plurality of fasteners 102. The fasteners 102 secure the aft case 76 to the outer case 62. In this example the aft turbine case 76 surrounds and circumscribes the low pressure turbine 46.

The elimination of a flange between the forward end 70 and the aft end 72 of the outer case 62 simplifies assembly, enables reduction of weight of the engine static structure 36, and reduces a potential air leakage path through the flange, without sacrificing structural stability. The example outer case 62 provides a one-piece continuous structure between the combustor case 74 and the aft turbine case 76 that simplifies assembly by eliminating an attachment point.

Although a combination of features is shown in the illustrated examples, not all of them need to be combined to realize the benefits of various embodiments of this disclosure. In other words, a system designed according to an embodiment of this disclosure will not necessarily include all of the features shown in any one of the Figures or all of the portions schematically shown in the Figures. Moreover, selected features of one example embodiment may be combined with selected features of other example embodiments.

The preceding description is exemplary rather than limiting in nature. Variations and modifications to the disclosed examples may become apparent to those skilled in the art that do not necessarily depart from the essence of this disclosure. The scope of legal protection given to this disclosure can only be determined by studying the following claims.

What is claimed is:

1. A case for a gas turbine engine comprising:
a single unitary outer case including a turbine portion and a transition portion, the outer case including a forward end attachable to a combustor case and an aft end attachable to an aft turbine case.

2. The case as recited in claim 1, including a turbine intermediate frame supported within the transition portion.

3. The case as recited in claim 1, wherein the outer case includes at least one continuous uninterrupted outer surface that extends from the forward end to the aft end.

4. The case as recited in claim 1, wherein the turbine portion at least partially surrounds a high pressure turbine.

5. The case as recited in claim 1, including a mounting flange disposed about an outer surface of the outer case between the forward end and the aft end.

6. The case as recited in claim 1, including hooks within the turbine portion for supporting at least one blade outer seal assembly.

7. The case as recited in claim 6, including hooks for supporting at least one vane.

8. A gas turbine engine comprising:
a compressor section disposed within a combustor case;
a combustor section;
a first turbine section and a second turbine section;
a single-piece outer case including a turbine portion and a transition portion; and
an aft turbine case, wherein the outer case includes a forward end attachable to the combustor case and an aft end attachable to the aft turbine case.

9. The gas turbine engine as recited in claim 8, wherein the turbine portion surrounds the first turbine section and the aft turbine case surrounds the second turbine section.

10. The gas turbine engine as recited in claim 8, including a turbine intermediate frame supported within the transition portion of the outer case.

11. The gas turbine engine as recited in claim 8, wherein the outer case includes a continuous uninterrupted outer surface that extends from the forward end to the aft end.

12. The gas turbine engine as recited in claim 8, including a mounting flange disposed about an outer surface of the outer case between the forward and aft ends.

13. The gas turbine engine as recited in claim 8, wherein the turbine portion of the outer case includes hooks for supporting a blade outer seal assembly.

14. The gas turbine engine as recited in claim 8, including hooks for supporting at least one vane.

15. A method of assembling a gas turbine engine comprising:
defining an outer case as a single unitary structure that includes a turbine portion for a first turbine and a transition portion for a turbine intermediate frame;
attaching a forward end of the outer case to a combustor case such that the turbine portion of the outer case surrounds the first turbine;
assembling the turbine intermediate frame into the transition portion of the outer case; and
attaching an aft turbine case to an aft end of the outer case.

16. The method as recited in claim 15, including configuring the outer case to include at least one continuous uninterrupted outer surface that extends from the forward end to the aft end.

17. The method as recited in claim 15, including assembling a blade outer air seal assembly within the turbine portion of the outer case.

18. The method as recited in claim 15, including assembling a bearing assembly into the outer case within the transition portion prior to attaching of the aft turbine case.

19. The method as recited in claim 15, including defining a mounting flange for attaching accessory components on an outer surface of the outer case between the forward end and the aft end.
